(19) United States
(12) Patent Application Publication
(10) Pub. No.: US 2026/0188556 A1
(43) Pub. Date: Jul. 2, 2026

(54) MAGNETIC UNIT

(71) Applicant: Yazaki Corporation, Tokyo (JP)

(72) Inventors: Masayo MATSUURA, Shizuoka (JP); Takuto MISHIGE, Shizuoka (JP); Kenji SEGAWA, Shizuoka (JP); Takanori KANAMORI, Shizuoka (JP); Junya ISHIDA, Shizuoka (JP)

(73) Assignee: Yazaki Corporation, Tokyo (JP)

(21) Appl. No.: 19/419,319

(22) Filed: Dec. 15, 2025

(30) Foreign Application Priority Data
Dec. 16, 2024 (JP) 2024-219717

(51) Int. Cl. H01F 27/24; H01F 27/02

(52) U.S. Cl. CPC H01F 27/24; H01F 27/02

(57) ABSTRACT

A magnetic unit includes a magnetic core including a first core and a second core, a base member that accommodates the magnetic core and includes a bottom part that supports the first core and a sidewall part that is provided on a side of the magnetic core, and a plate spring with an end part in the second direction held by the sidewall part, the biasing member being configured to bias the second core to the other side in the third direction.

### CROSS-REFERENCE TO RELATED APPLICATION(S)

The present application claims priority to and incorporates by reference the entire contents of Japanese Patent Application No. 2024-219717 filed in Japan on Dec. 16, 2024.

### BACKGROUND OF THE INVENTION

### 1. Field of the Invention

The present invention relates to a magnetic unit.

### 2. Description of the Related Art

As one example of the conventional art regarding a magnetic unit, Japanese Patent Application Laid-open No. 2001-135526 discloses a magnetic unit including a clamp, which is a biasing member including an upper surface part and a pair of leg parts, provided at an upper surface opening of a case that accommodates a coil and a magnetic core and is fixed to a table. The clamp includes a long leg and a short leg extending from the upper surface part and the long leg is locked to a bottom surface of the case and the short leg is locked to a projecting piece projecting from a side surface of the case.

In such a magnetic unit, incidentally, when the clamp is assembled to the case, for example, it is necessary to insert and lock the long leg between the narrow table and the bottom surface of the case, which may make the assembling work difficult. There is room for further improvement in the configuration for assembling the biasing member to the case.

### SUMMARY OF THE INVENTION

The present invention was made in view of the above circumstances and aims to provide a magnetic unit that can properly realize a configuration for assembling the biasing member to the case.

To achieve the objection, a magnetic unit according to one aspect of the present invention includes a magnetic core formed in an annular shape about a first direction and including a first core and a second core split along a second direction that intersects with the first direction, in which the second core provided on one side in a third direction that intersects with the first direction and the second direction and the first core provided on the other side in the third direction are in contact with each other along the third direction; a base member that accommodates the magnetic core and includes a bottom part that supports the first core and a sidewall part that is provided on a side of the magnetic core in the second direction; and a biasing member with an end part in the second direction held by the sidewall part, the biasing member being configured to bias the second core to the other side in the third direction, wherein the sidewall part includes a biasing member locking part that is locked to the end part of the biasing member, the biasing member includes a bent end part corresponding to an end part that is bent toward one side in the third direction, and the biasing member locking part includes a locking projection that projects to the other side in the third direction so as to be locked to the bent end part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a magnetic unit according to a first embodiment;

FIG. 2 is an exploded perspective view illustrating the magnetic unit according to the first embodiment;

FIG. 3 is a perspective view of a base member according to the first embodiment;

FIG. 4 is a cross-sectional view taken along IV-IV in FIG. 3;

FIG. 5 is a perspective view illustrating a bobbin according to the first embodiment;

FIG. 6 is a perspective view illustrating a plate spring according to the first embodiment;

FIG. 7 is a cross-sectional view taken along VII-VII in FIG. 1;

FIG. 8 is a perspective view illustrating a state before the plate spring is attached to the base member according to the first embodiment;

FIG. 9 is a cross-sectional view corresponding to a cross section taken along VII-VII in FIG. 1, illustrating a state in which an inclined contact part of the plate spring is inserted to a biasing member holding part;

FIG. 10 is a perspective view illustrating a magnetic unit according to a second embodiment;

FIG. 11 is a perspective view illustrating a plate spring according to the second embodiment;

FIG. 12 is a cross-sectional view taken along XII-XII in FIG. 10;

FIG. 13 is a perspective view illustrating a state before the plate spring is attached to the base member according to the second embodiment;

FIG. 14 is a cross-sectional view corresponding to a cross section taken along XII-XII in FIG. 10, illustrating a state in which an inclined contact part of the plate spring is inserted to a biasing member holding part; and

FIG. 15 is a perspective view illustrating an example of incorrect assembly of the plate spring according to the second embodiment.

### DETAILED DESCRIPTION OF THE PREFERRED EMBODIMENTS

Embodiments according to the present invention will hereinafter be described in detail on the basis of the drawings. Note that the present invention is not limited by the embodiments. In addition, the components in the following embodiments include those that are substitutable and easily conceivable for persons who are skilled in the art, or those that are substantially the same.

### First Embodiment

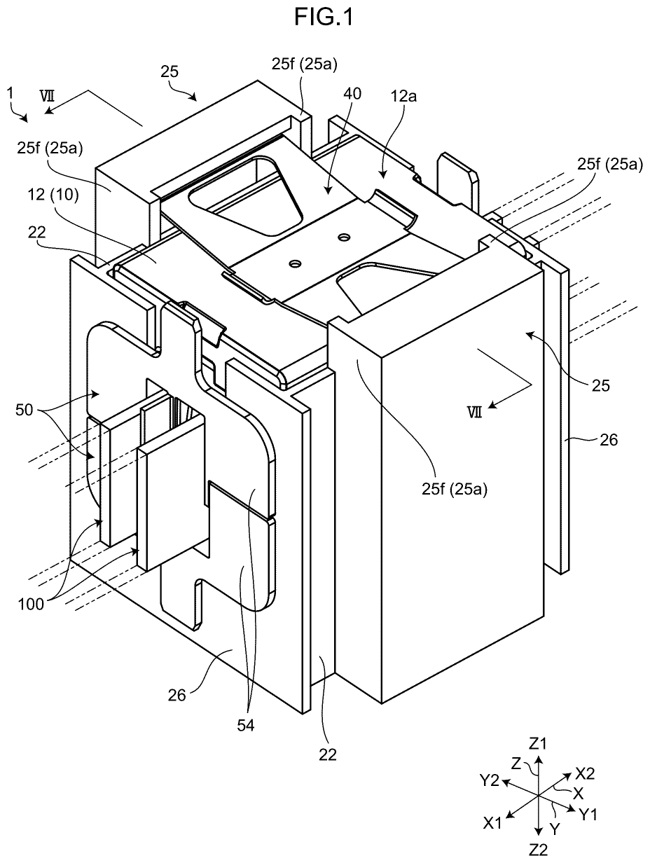

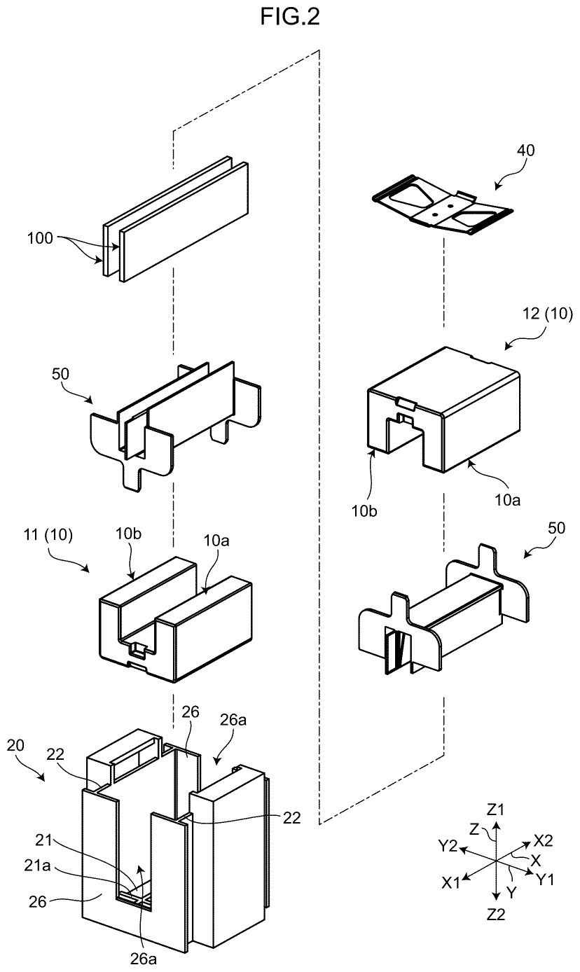

A first embodiment is described based on FIG. 1 to FIG. 9. A magnetic unit 1 according to the first embodiment illustrated in FIG. 1 and FIG. 2 is, for example, provided in a high-voltage junction box to which a high-voltage battery pack mounted in a vehicle, such as an electric vehicle or a hybrid vehicle, is electrically connected. In the magnetic unit 1, busbars 100 are inserted to a magnetic core 10 with an annular shape that includes split cores, that is, a first core 11 and a second core 12. The busbar 100 is a circuit body (conductor) that forms a high-voltage circuit system including a high-voltage battery pack and the like. The magnetic unit 1 including the magnetic core 10 can suitably remove high-frequency noise in the busbar 100 and suitably suppress surge voltages.

The magnetic unit 1 includes the magnetic core 10, a base member 20, a plate spring 40 as a biasing member, and two bobbins 50. Two busbars 100 are inserted to the magnetic core 10, which is formed in an annular shape. The busbar 100 is formed in a long shape, and is illustrated only partially in the drawing. The magnetic core 10 and the two bobbins 50 to which the busbars 100 are inserted are accommodated in the base member 20, which is a case.

In the following description, an axial direction of the annular magnetic core 10 in which the two busbars 100 extend is a first direction X, and two directions that are orthogonal to the first direction X are a second direction Y and a third direction Z. The second direction Y is the direction in which the two busbars 100 are arranged. One side in the first direction X is described as one side X1 and the other side is described as the other side X2 below. Similarly, one side and the other side in the second direction Y are described as one side Y1 and the other side Y2 and one side and the other side in the third direction Z are described as one side Z1 and the other side Z2, respectively.

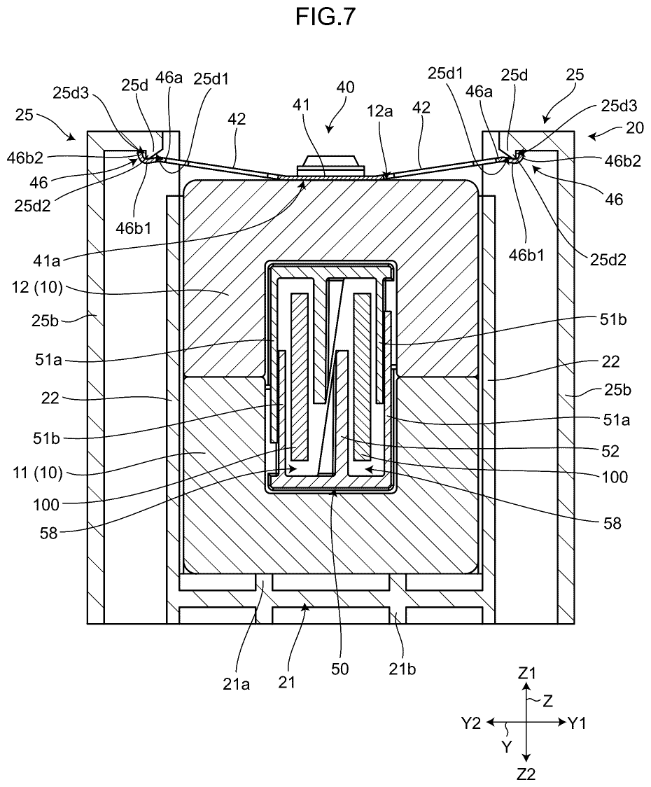

As illustrated in FIG. 2, the magnetic core 10 includes the first core 11 and the second core 12 split along the second direction Y. The first core 11 is provided on the other side Z2 in the third direction Z, and the second core 12 is provided on one side Z1 in the third direction Z. The magnetic core 10 is formed annularly about the first direction X with the first core 11 and the second core 12 combined (see also FIG. 7). The first core 11 and the second core 12 are formed in the same shape and are formed of a magnetic material such as ferrite. The first core 11 and the second core 12 have an approximately U-like shape as viewed from the first direction X, and are long along the first direction X. Of the first core 11 and the second core 12, two flat surfaces located on the open side of the approximately U-like shape are contact surfaces 10a and 10b. In the magnetic core 10, the respective contact surfaces 10a and 10b of the first core 11 and the second core 12 are in contact with each other along the third direction Z.

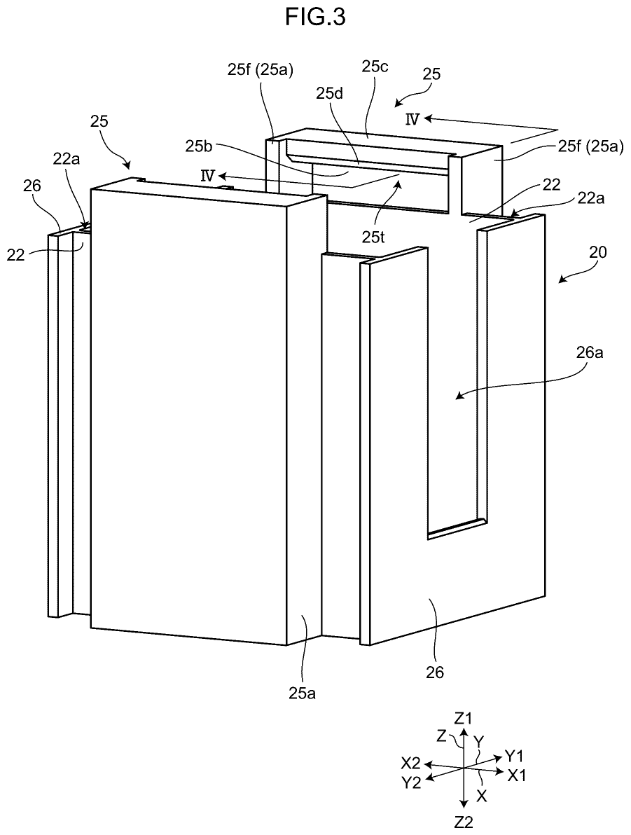

As illustrated in FIG. 2 and FIG. 3, the base member 20 is formed in an approximately cuboid box-like shape with an opening on one side Z1 in the third direction Z. The base member 20 has an approximately long rectangular plate-shaped bottom part 21 that is approximately parallel to a plane containing the first direction X and the second direction Y. On one side Z1 of the bottom part 21 in the third direction Z, a core support part 21a is formed in a grid pattern. A surface of the core support part 21a on one side Z1 in the third direction Z is in contact with, and supports the surface of the first core 11 on the other side Z2 in the third direction Z. As illustrated in FIG. 7, a rib 21b with the grid pattern similar to that of the core support part 21a is also formed at the bottom part 21 on the other side Z2 in the third direction Z.

At an end part of the bottom part 21 on one side Y1 in the second direction Y and an end part thereof on the other side Y2, two sidewall parts 22 rising toward one side Z1 in the third direction Z are provided as illustrated in FIG. 2 and FIG. 3. The sidewall part 22 has an approximately plate-like shape with a plate surface facing in the second direction Y. The sidewall parts 22 are each located on the side of the magnetic core 10 in the second direction Y (see FIG. 7). At each end part of each of the sidewall parts 22 on one side X1 and the other side X2 in the first direction X, an insertion plate part 26 with an approximately plate-like shape is provided. Each of the insertion plate parts 26 is provided with a plate surface facing in the first direction X. Each of the insertion plate parts 26 has an insertion opening 26a that is long along the third direction Z at a substantial center in the second direction Y. The bobbin 50 is disposed in the insertion opening 26a and the busbar 100 is inserted therethrough.

At each of the two sidewall parts 22, a biasing member locking part 25 is provided as illustrated in FIG. 3. The biasing member locking part 25 is formed in an approximately box-like shape on the outside of the sidewall part 22. The biasing member locking part 25 projects to one side Z1 in the third direction Z compared to an end surface 22a of the sidewall part 22 on one side Z1 in the third direction Z. The biasing member locking part 25 of the sidewall part 22 on one side Z1 in the third direction Z includes an insertion port 25t that opens inward. The biasing member locking part 25 on one side Y1 in the second direction Y and the biasing member locking part 25 on the other side Y2 are formed in symmetry about the first direction X. The biasing member locking part 25 on one side Y1 in the second direction Y will be described below and the detailed description of the biasing member locking part 25 on the other side Y2 will be omitted.

The biasing member locking part 25 has two side plates 25a provided with their plate surfaces facing in the first direction X while being separated from each other by a predetermined distance in the first direction X. The other side Y2 of the two side plates 25a in the second direction Y is connected to the sidewall part 22. The two side plates 25a project to one side Z1 compared to the end surface 22a of the sidewall part 22 on one side Z1 in the third direction Z. A part of the side plate 25a that projects to one side Z1 relative to the end surface 22a of the sidewall part 22 on one side Z1 in the third direction Z serves as a regulatory wall part 25f.

One side Y1 of the two side plates 25a in the second direction Y is connected to a support plate 25b. The support plate 25b is provided with its plate surface facing in the second direction Y. The length of the support plate 25b in the third direction Z is the same as the length of the side plate 25a in the third direction Z. The support plate 25b and the two side plates 25a are each connected to a locking plate 25c on one side Z1 in the third direction Z. The locking plate 25c is provided with its plate surface facing in the third direction Z. The locking plate 25c is long along the first direction X.

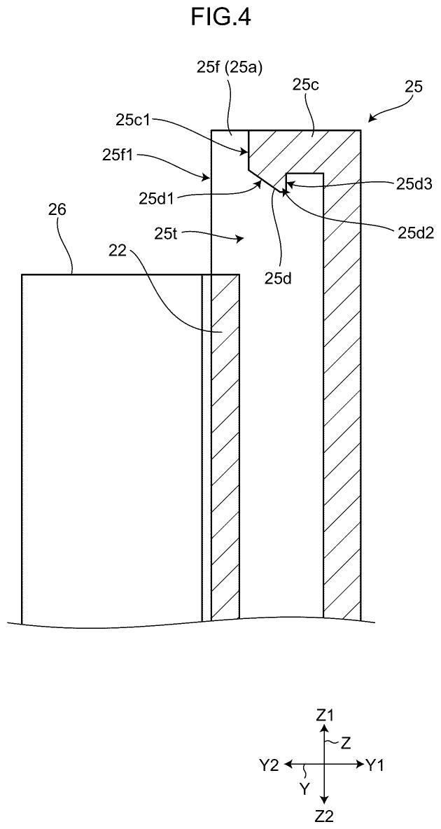

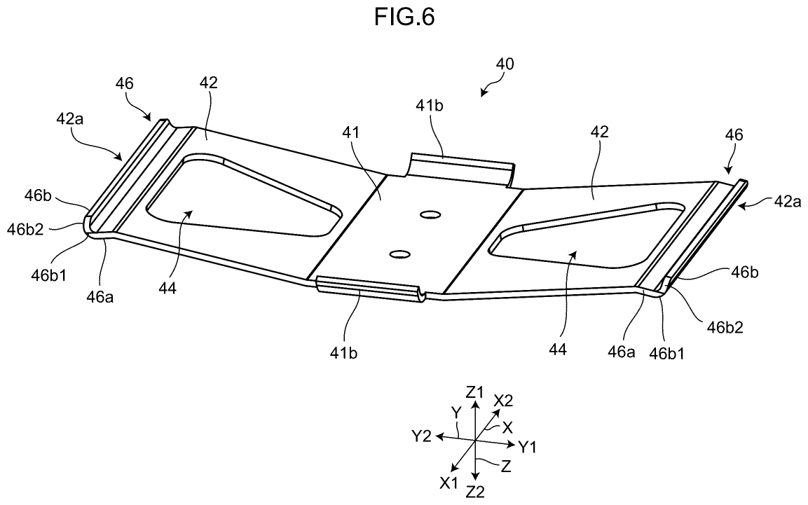

As illustrated in FIG. 3 and FIG. 4, a locking projection 25d that projects toward the other side Z2 is provided on the other side Z2 of the locking plate 25c in the third direction Z. To the locking projection 25d, a bent end part 46 of the plate spring 40 is locked (see FIG. 6 and FIG. 7). The locking projection 25d is provided at an edge of the locking plate 25c on the other side Y2 in the second direction Y. The locking projection 25d is provided in a long shape along the first direction X so as to be connected to each of the two side plates 25a (regulatory wall part 25f). In other words, the regulatory wall parts 25f are provided at both ends of the locking projection 25d along the first direction X. As illustrated in FIG. 4, the locking projection 25d has a guide inclined surface 25d1 that is inclined on the magnetic core 10 side. The guide inclined surface 25d1 is inclined from one side Z1 to the other side Z2 in the third direction Z along one side Y1 from the other side Y2 in the second direction Y (in other words, from the inside to the outside of the sidewall part 22). The other side Y2 of the guide inclined surface 25d1 in the second direction Y is connected to an end surface 25c1 of the locking plate 25c on the other side Y2 in the second direction Y. One side Y1 of the guide inclined surface 25d1 in the second direction Y is connected to a jaw surface 25d3 through a projecting end 25d2 of the locking projection 25d. The jaw surface 25d3 is formed as a plane parallel to a plane containing the first direction X and the third direction Z. Note that an end surface 25f1 of the regulatory wall part 25f on the other side Y2 in the second direction Y (that is, on the inside) is continuously provided on the same plane as the inner side surface of the sidewall part 22. Therefore, the end surface 25f1 of the regulatory wall part 25f projects to the inside, that is, to the other side Y2 in the second direction Y, relative to the end surface 25c1 of the locking plate 25c.

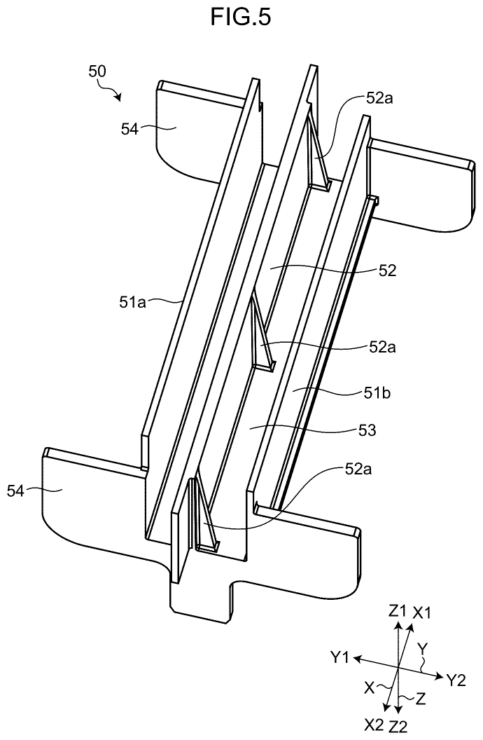

As illustrated in FIG. 2, the two bobbins 50 are provided facing each other along the third direction Z. Note that the two bobbins 50 are identical in shape. As illustrated in FIG. 5, the bobbin 50 includes two side plates 51a and 51b provided apart from each other, and a partition plate 52 provided between the two side plates 51a and 51b. Each of the side plates 51a and 51b and the partition plate 52 is formed in an approximately long rectangular shape that is long in the first direction X and has its plate surface facing in the second direction Y. Each of the side plates 51a and 51b and the partition plate 52 is connected by a bottom plate 53 at an end part in the third direction Z (end part on the other side Z2 in FIG. 5). The height, in the third direction Z, of the side plate 51a on one side Y1 in the second direction Y as illustrated in FIG. 5 is higher than that of the side plate 51b on the other side Y2 and the partition plate 52. On the other side Y2 of the partition plate 52 in the second direction Y, three ribs 52a that connect to the bottom plate 53 are provided. In each of the side plates 51a and 51b, a stop plate 54 is provided at each of end parts on one side X1 and the other side X2 in the first direction X. The stop plate 54 is provided with its plate surface facing in the first direction X. The stop plate 54 has an opening corresponding to the space between the side plates 51a and 51b and includes a part projecting to the outside of the side plates 51a and 51b.

The two bobbins 50 facing each other in the third direction Z are disposed inside the annular shape of the magnetic core 10, and busbar insertion paths 58 are formed on one side Y1 and the other side Y2 of the partition plates 52 in the second direction Y (see FIG. 7). Note that the partition plates 52 overlap with each other near the end part in the third direction Z. An inner side surface of the stop plate 54 of each bobbin 50 is close to, or in contact with an outer side surface of the insertion plate part 26 of the base member 20 (see FIG. 1).

As illustrated in FIG. 6, the plate spring 40 is formed in the approximately long rectangular plate-like shape whose longitudinal direction corresponds to the second direction Y. The plate spring 40 is formed in an approximately concave shape using a sheet metal material. A central part of the plate spring 40 in the second direction Y is formed in an approximately flat-plate shape and corresponds to a biasing contact part 41 that is in contact with the second core 12. The biasing contact part 41 is formed in the approximately long rectangular shape that is long in the first direction X. At each of end parts of the biasing contact part 41 on one side X1 and the other side X2 in the first direction X, a bent part 41b that is bent toward one side Z1 in the third direction Z is provided. On each of one side Y1 and the other side Y2 of the biasing contact part 41 in the second direction Y, an inclined contact part 42 is provided. Each inclined contact part 42 is formed by a bending process to form an inclination from the biasing contact part 41 toward one side Z1 in the third direction Z. That is to say, the inclined contact part 42 is formed so as to be inclined from one side Z1 to the other side Z2 in the third direction Z from each end part 42a of the plate spring 40 on one side Y1 and the other side Y2 toward the biasing contact part 41 along the second direction Y.

The end part 42a of each inclined contact part 42 is formed in a straight line shape along the first direction X. At the end part 42a of each inclined contact part 42, the bent end part 46 is formed. The bent end part 46 includes a bent base part 46a that is bent a little toward the other side Z2 in the third direction Z with respect to the inclination direction of the inclined contact part 42, and a bent locking part 46b that is bent from the bent base part 46a to one side Z1 in the third direction Z. The bent locking part 46b includes a bent part 46b1 connecting to the bent base part 46a and a rising part 46b2 rising from the bent part 46b1 to one side Z1 in the approximately third direction Z.

The inclined contact part 42 on one side Y1 in the second direction Y includes an attachment regulatory plate part 47 that projects in a flat plate shape from an edge on one side X1 in the first direction X in the vicinity of the bent base part 46a of the bent end part 46.

As illustrated in FIG. 7, when the plate spring 40 is assembled to the base member 20, a surface 41a of the biasing contact part 41 of the plate spring 40 on the other side Z2 in the third direction Z is in contact with a surface 12a of the second core 12 on one side Z1. The bent end part 46 of the plate spring 40 is locked with the locking projection 25d of the biasing member locking part 25. More specifically, the projecting end 25d2 of the locking projection 25d comes into contact with the bent part 46b1 of the bent locking part 46b of the bent end part 46, and the rising part 46b2 of the bent locking part 46b faces the jaw surface 25d3 of the locking projection 25d in the second direction Y. In this way, both ends of the plate spring 40 in the second direction Y are held, so that the end parts 42a of the inclined contact parts 42 at two positions facing each other along the second direction Y are held in a state of having shifted from the steady state to the other side Z2 in the third direction Z against the biasing force of the inclined contact parts 42 of the plate spring 40. In other words, the plate spring 40 is held in the biased state. On the other hand, the first core 11 is supported by the core support part 21a at the bottom part 21 of the base member 20A. Therefore, the plate spring 40 bias es the second core 12 to the other side Z2 in the third direction Z (that is, the first core 11).

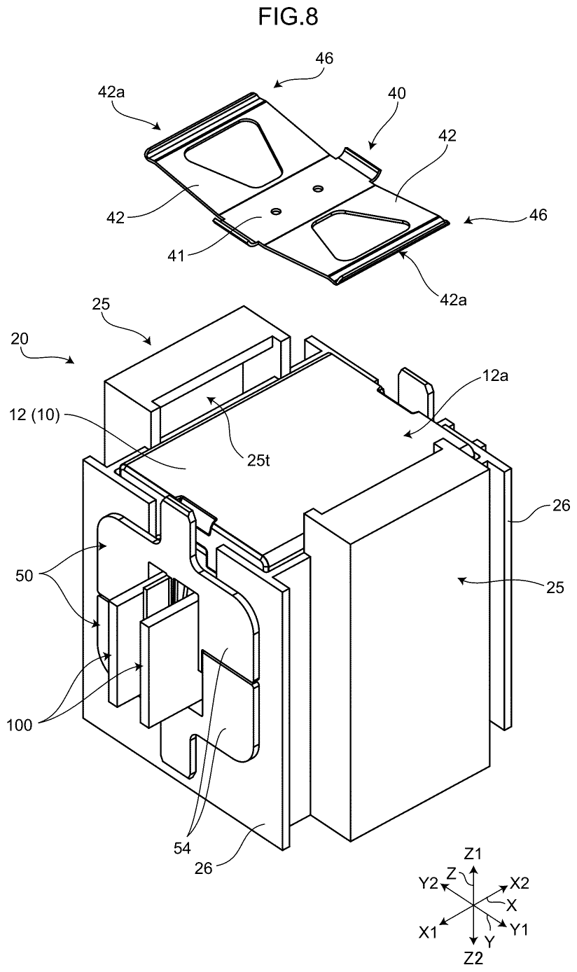

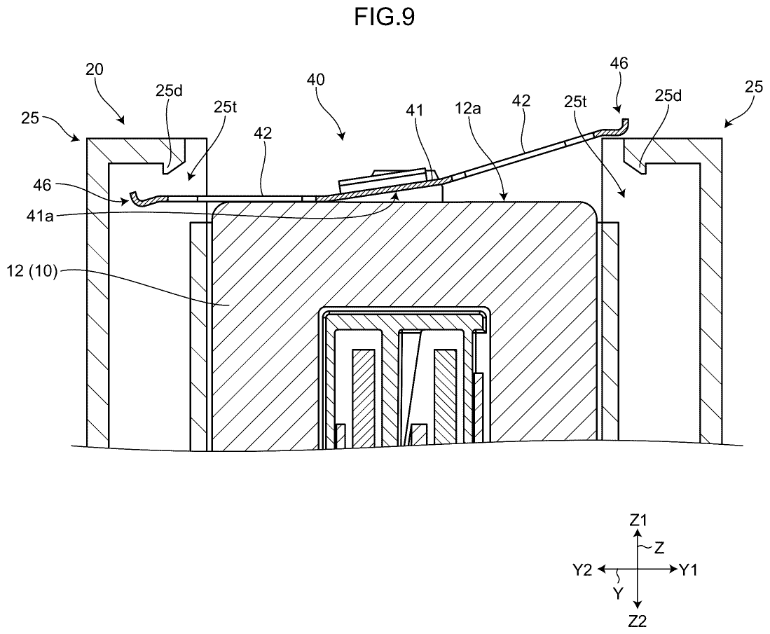

The plate spring 40 is assembled as follows. First, as illustrated in FIG. 8, the plate spring 40 is mounted on the second core 12 from one side Z1 in the third direction Z with respect to the base member 20 that accommodates the magnetic core 10 and the two bobbins 50 with the busbars 100 inserted thereto. At this time, the plate spring 40 is oriented so that its longitudinal direction (that is, the end part 42a of the plate spring 40) extends along the second direction Y. Then, as illustrated in FIG. 9, the end part 42a of the plate spring 40 on the other side Y2 in the second direction Y is inserted to an insertion port 23t of the biasing member locking part 25 on the other side Y2 in the second direction Y. At this time, a surface 42b, on the other side Z2 in the third direction Z, of the inclined contact part 42 to be inserted to the insertion port 23t in the plate spring 40 and the surface 12a of the second core 12 on one side Z1 in the third direction Z are brought into contact with each other and the inclined contact part 42 to be inserted to the insertion part 23t is inserted to the insertion part 23t by sliding. This is suitable because the work is facilitated. Then, the inclined contact part 42 of the plate spring 40 on one side Y1 in the second direction Y is pushed toward the other side Z2 in the third direction Z, that is, the bent end part 46 of the plate spring 40 on one side Y1 in the second direction Y is pushed toward the biasing member locking part 25. Then, in the pushed-in bent end part 46 of the plate spring 40, an outer side surface 46b3 of the bent locking part 46b is in slide contact with the end surface 25c1 of the locking plate 25c, and the bent base part 46a is elastically curved. Then, in the bent locking part 46b, the guide inclined surface 25d1 of the locking projection 25d guides a projecting end part of the bent locking part 46b and the like in slide contact, causing the projecting end 25d2 of the locking projection 25d to be fitted into the bent part 46b1 of the bent locking part 46b. On the other hand, the bent end part 46 of the plate spring 40 on the other side Y2 in the second direction Y moves to one side Z1 in the third direction Z and is locked to the locking projection 25d as the bent end part 46 on one side Y1 is pushed into the biasing member locking part 25. In this manner, the bent end parts 46 of the plate spring 40 on both ends are locked to the locking projections 25d of the biasing member locking parts 25 and the state in FIG. 7 is obtained.

### Second Embodiment

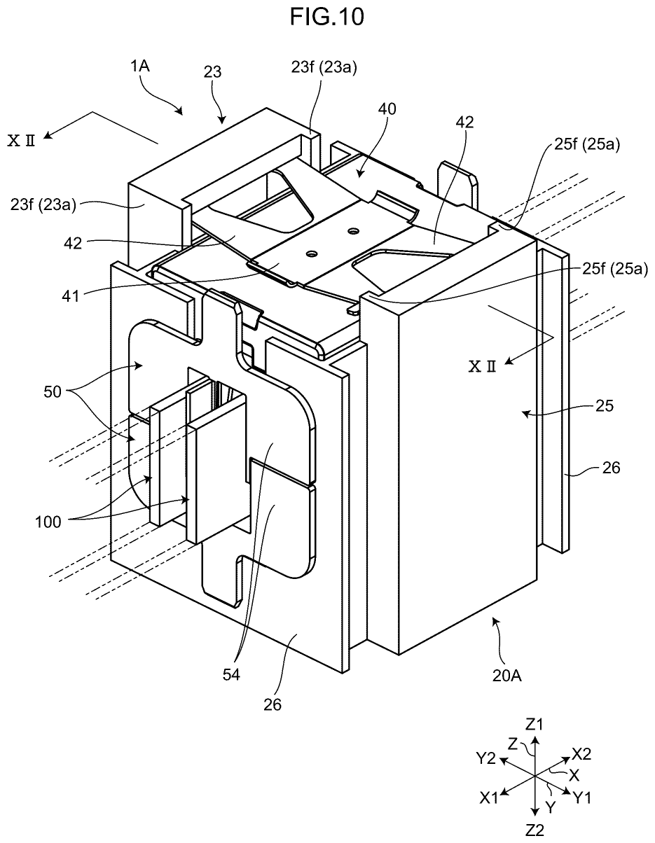

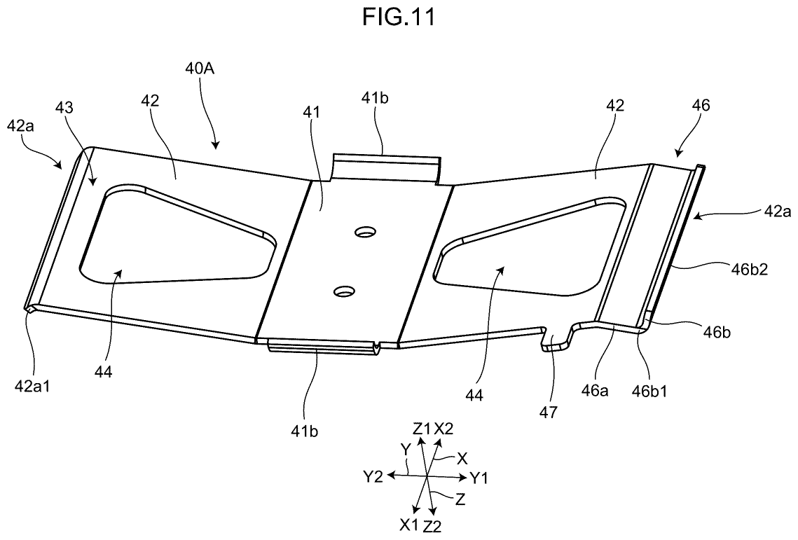

Next, a second embodiment is described based on FIG. 10 to FIG. 15. As illustrated in FIG. 10 and FIG. 11, a magnetic unit 1A according to this embodiment includes a plate spring 40A instead of the plate spring 40 in the first embodiment. The plate spring 40A includes the bent end part 46 in one inclined contact part 42 and a biasing member side inclined contact surface 43 in the other inclined contact part 42. Moreover, the magnetic unit 1A according to this embodiment includes a base member 20A instead of the base member 20 including the biasing member locking parts 25 on both sides of one side Y1 and the other side Y2 in the second direction Y in the first embodiment. The base member 20A includes the biasing member locking part 25 on one side Y1 in the second direction Y and a biasing member holding part 23 including a sidewall part side inclined contact surface 23d to which the biasing member side inclined contact surface 43 of the plate spring 40A is locked on the other side Y2. Hereinafter, the same components and the same parts as those in the first embodiment will be denoted with the same symbols, and the description thereof will be omitted or simplified.

The sidewall part 22 of the base member 20A on one side Y1 in the second direction Y includes the biasing member locking part 25. The sidewall part 22 of the base member 20 on the other side Y2 in the second direction Y includes the biasing member holding part 23. The biasing member holding part 23 has two side plates 23a with their plate surfaces facing in the first direction X, and the two side plates 23a are provided with a predetermined gap therebetween in the first direction X. One side Y1 of the two side plates 23a in the second direction Y is connected to the sidewall part 22. The other side Y2 of the two side plates 23a in the second direction Y is connected to a support plate 23b. The support plate 23b is provided with its plate surface facing in the second direction Y. The support plate 23b has the same length in the third direction Z as the two side plates 23a. The support plate 23b and the two side plates 23a are each connected to a locking plate 23c on one side Z1 in the third direction Z. The locking plate 23c is provided with its plate surface facing in the third direction Z. The locking plate 23c is long along the first direction X.

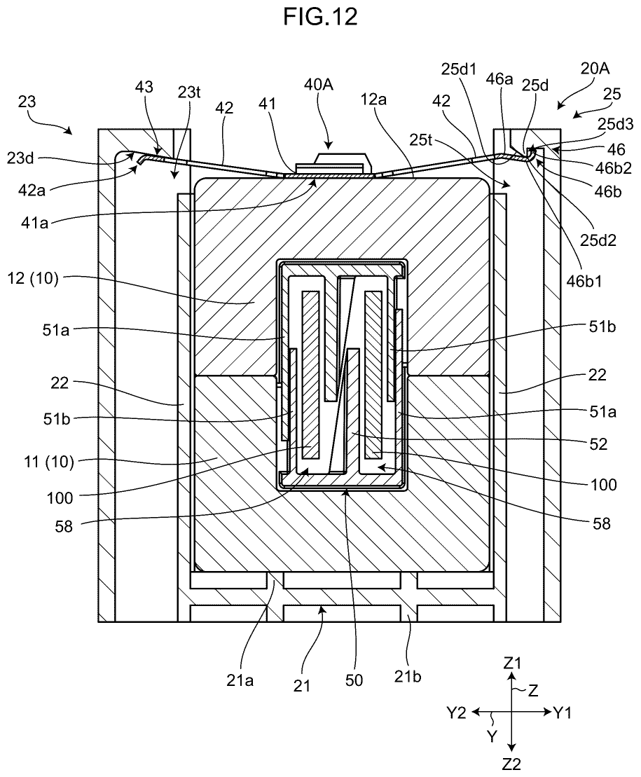

On the other side Z2 of the locking plate 23c in the third direction Z, the sidewall part side inclined contact surface 23d is provided (see FIG. 12). The sidewall part side inclined contact surface 23d is inclined from one side Z1 to the other side Z2 in the third direction Z along the other side Y2 to one side Y1 in the second direction Y (in other words, along the direction from the outside to the inside of the sidewall part 22). The sidewall part side inclined contact surface 23d is long along the first direction X. Regulatory wall parts 23f are provided on one side X1 and the other side X2 in the first direction X in the sidewall part side inclined contact surface 23d (that is, at both ends of the sidewall part side inclined contact surface 23d). Therefore, the internal space of the biasing member holding part 23 is closed on the outside of the biasing member holding part 23 and in the direction along the first direction X. A part of the side plate 23a that projects to one side Z1 relative to the end surface 22a of the sidewall part 22 on one side Z1 in the third direction Z serves as the regulatory wall part 23f. Thus, the regulatory wall part 23f is a part of the side plate 23a. The biasing member holding part 23 is open on one side Z1 relative to the end surface 22a of the sidewall part 22 on one side Z1 in the third direction Z and this opening corresponds to the insertion port 23t. An inner end surface 23f1 of the regulatory wall part 23f in this embodiment is located on the same plane as the inner side surface of the sidewall part 22 and is continuous (see also FIG. 12). Thus, the inner end surface 23f1 of the regulatory wall part 23f projects inwardly relative to an inner end surface 23c1 of the locking plate 23c.

As illustrated in FIG. 11, the plate spring 40A is formed in the approximately long rectangular plate-like shape whose longitudinal direction corresponds to the second direction Y. The plate spring 40A is formed in an approximately concave shape using a sheet metal material. The plate spring 40A includes the biasing contact part 41 in contact with the second core 12, and the inclined contact parts 42 provided on one side Y1 and the other side Y2 in the second direction Y at the biasing contact part 41. The inclined contact part 42 is formed so as to be inclined from one side Z1 to the other side Z2 in the third direction Z from each end part 42a of the plate spring 40A on one side Y1 and the other side Y2 toward the biasing contact part 41 along the second direction Y. At the end part 42a of the inclined contact part 42 on one side Y1 in the second direction Y, the bent end part 46 is formed. The end part 42a of the inclined contact part 42 on the other side Y2 in the second direction Y is formed in an approximately straight line shape along the first direction X and corresponds to a bent part 42a1 that is bent in the direction of the other side Z2 in the approximately third direction Z. The surface of the inclined contact part 42 on the other side Y2 in the second direction Y in the vicinity of the end part 42a on one side Z1 in the third direction Z corresponds to the biasing member side inclined contact surface 43. The biasing member side inclined contact surface 43 is formed, similar to the inclined contact part 42, so as to be inclined from one side Z1 to the other side Z2 in the third direction Z from the end part 42a of the inclined contact part 42 toward the biasing contact part 41 along the second direction Y.

As illustrated in FIG. 12, when the plate spring 40A is assembled to the base member 20A, the surface 41a of the biasing contact part 41 of the plate spring 40A on the other side Z2 in the third direction Z is in contact with the surface 12a of the second core 12 on one side Z1. The bent end part 46 of the inclined contact part 42 of the plate spring 40A on one side Y1 in the second direction Y is locked with the locking projection 25d of the biasing member locking part 25. The biasing member side inclined contact surface 43 of the inclined contact part 42 of the plate spring 40A on the other side Y2 in the second direction Y is in contact (surface contact) with the sidewall part side inclined contact surface 23d of the biasing member holding part 23. In this way, both ends of the plate spring 40A in the second direction Y are held, so that the end parts 42a of the inclined contact parts 42 at two positions facing each other along the second direction Y are held in a state of having shifted from the steady state to the other side Z2 in the third direction Z against the biasing force of the inclined contact parts 42 of the plate spring 40A. In other words, the plate spring 40A is held in the biased state. On the other hand, the first core 11 is supported by the core support part 21a at the bottom part 21 of the base member 20A. Therefore, the plate spring 40A biases the second core 12 to the other side Z2 in the third direction Z (that is, the first core 11).

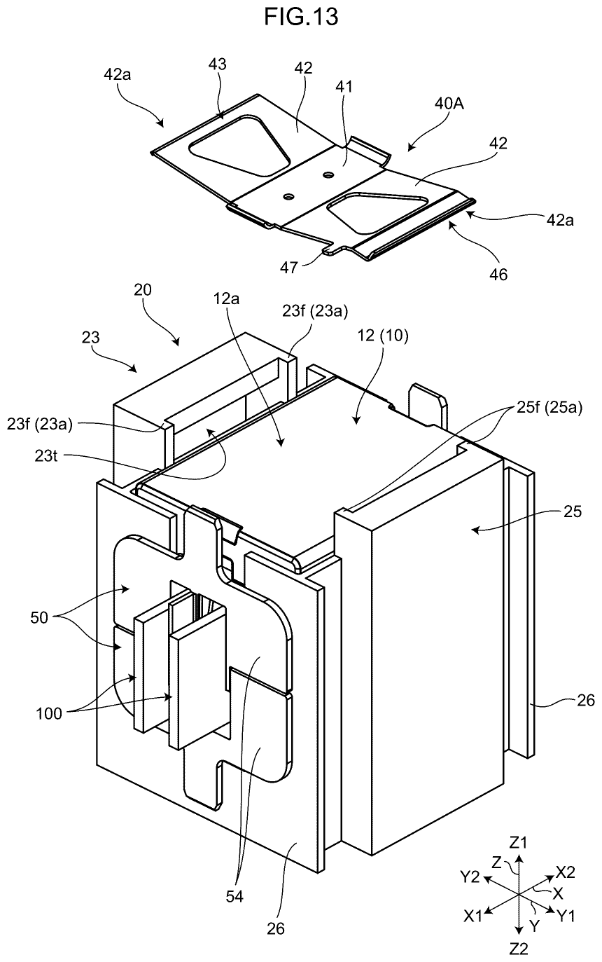

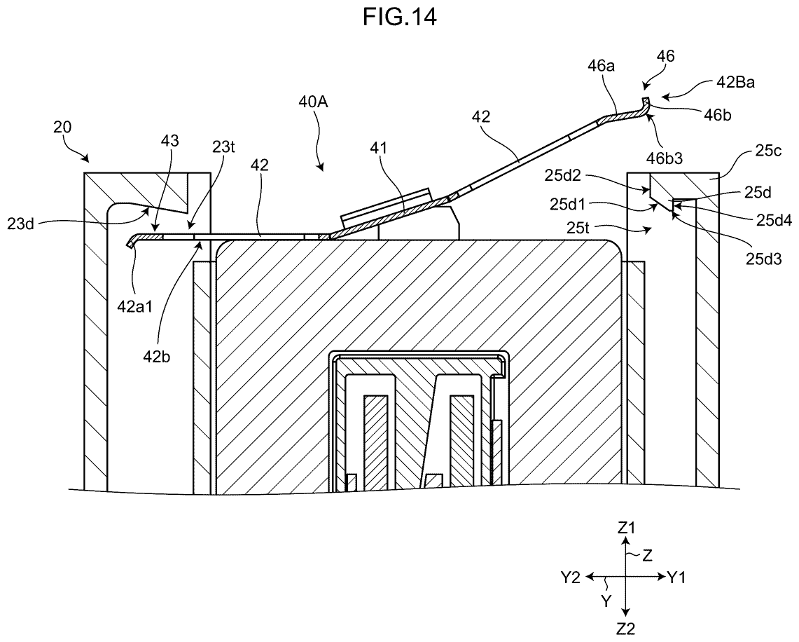

The plate spring 40A is assembled as follows. First, as illustrated in FIG. 13, the plate spring 40A is mounted on the second core 12 from one side Z1 in the third direction Z with respect to the base member 20A that accommodates the magnetic core 10 and the two bobbins 50 with the busbars 100 inserted thereto. At this time, the plate spring 40A is oriented so that its longitudinal direction (that is, the end part 42a of the plate spring 40A) extends along the second direction Y. Then, as illustrated in FIG. 14, the end part 42 a (bent part 42a1) of the plate spring 40A on the other side Y2 in the second direction Y is inserted to the insertion port 23t of the biasing member holding part 23. The end part 42a of the plate spring 40A on the other side Y2 in the second direction Y is inserted in such a way that the inclined contact part 42 on the other side Y2 in the second direction Y is disposed so that the biasing member side inclined contact surface 43 of the plate spring 40A and the sidewall part side inclined contact surface 23d face each other substantially in the third direction Z. At this time, the surface 42b of the inclined contact part 42 including the biasing member side inclined contact surface 43 in the plate spring 40A on the other side Z2 in the third direction Z and the surface 12a of the second core 12 on one side Z1 in the third direction Z are brought in contact with each other so that the inclined contact part 42 including the biasing member side inclined contact surface 43 is inserted to the insertion port 23t by sliding. This is suitable because the work is facilitated. Then, the inclined contact part 42 of the plate spring 40A on one side Y1 in the second direction Y is pushed toward the other side Z2 in the third direction Z, that is, the bent end part 46 of the plate spring 40A is pushed toward the biasing member locking part 25. At this time, the biasing member side inclined contact surface 43 of the plate spring 40A shifts to one side Z1 in the third direction Z, which brings the biasing member side inclined contact surface 43 and the sidewall part side inclined contact surface 23d into contact (surface contact) with each other. On the other hand, the pushed-in bent end part 46 of the plate spring 40A is locked with the locking projection 25d. In this way, the plate spring 40A is in the state illustrated in FIG. 20, where both ends are locked and held in the biased state.

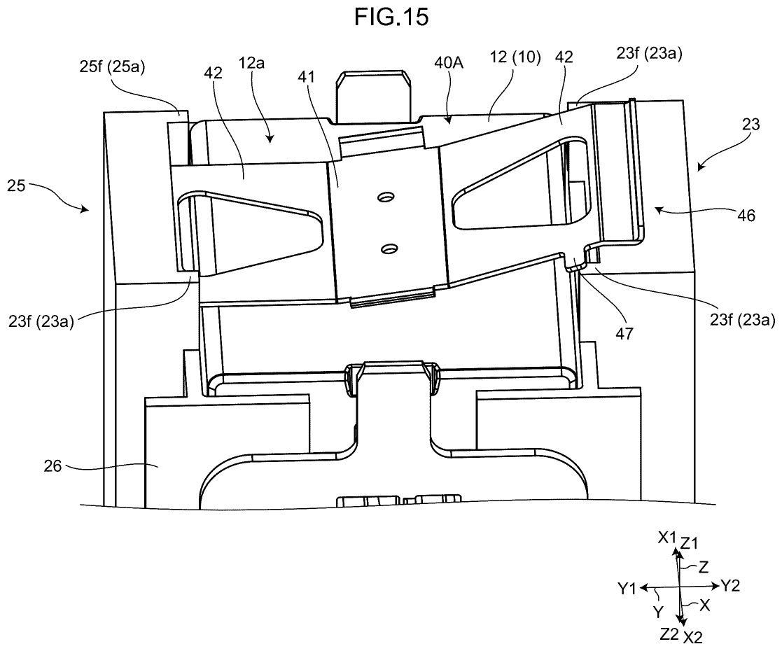

On the other hand, the incorrect assembly of the plate spring 40A is reduced by the interference of the attachment regulatory plate part 47 of the plate spring 40A with the biasing member holding part 23. For example, as illustrated in FIG. 15, in the case where the plate spring 40A is attached to the base member 20A with the bent end part 46 of the plate spring 40A oriented to the other side Y2 in the second direction Y and the inclined contact part 42 including the biasing member side inclined contact surface 43 oriented to one side Y1 in the second direction Y, the attachment regulatory plate part 47 of the plate spring 40A interferes with the regulatory wall part 23f of the biasing member holding part 23. Therefore, the plate spring 40A is not attached to the base member 20A in the wrong longitudinal direction, and problems such as detachment of the plate spring 40A due to such incorrect assembly are reduced.

The magnetic unit 1, 1A described above includes: the magnetic core 10 formed in the annular shape about the first direction X and including the first core 11 and the second core 12 split along the second direction Y that intersects with the first direction X, in which the second core 12 provided on one side Z1 in the third direction Z that intersects with the first direction X and the second direction Y and the first core 11 provided on the other side Z2 in the third direction Z are in contact with each other along the third direction Z; the base member 20, 20A that accommodates the magnetic core 10 and includes the bottom part 21 that supports the first core 11 and the sidewall part 22 that is provided on the side of the magnetic core 10 in the second direction Y; and the plate spring 40, 40A corresponding to the biasing member with the end part 42a in the second direction Y held by the sidewall part 22, the biasing member being configured to bias the second core 12 to the other side Z2 in the third direction Z, in which the sidewall part 22 includes the biasing member locking part 25 that is locked to the end part 42a of the plate spring 40, 40A, the plate spring 40, 40A includes the bent end part 46 corresponding to the end part 42a that is bent toward one side Z1 in the third direction Z, and the biasing member locking part 25 includes the locking projection 25d that projects to the other side Z2 in the third direction Z so as to be locked to the bent end part 46.

Thus, the bent end part 46 of the plate spring 40, 40A and the locking projection 25d of the biasing member locking part 25 are locked to each other and the end part 42a of the plate spring 40, 40A is locked and held for sure; thus, the plate spring 40, 40A will not be displaced easily. When the plate spring 40, 40A is assembled, sub-assembling of attaching the plate spring to the cover is not required and it is only necessary to push in the bent end part 46 of the plate spring 40, 40A or insert the bent end part 46 to the insertion port 25t simply; thus, the workability can be improved. In this manner, the configuration for assembling the plate spring 40, 40A corresponding to the biasing member to the base member 20, 20A, which is the case, can be properly achieved.

The locking projection 25d includes the guide inclined surface 25d1 that is inclined on the side of the magnetic core 10 in the second direction Y. Thus, when the bent end part 46 of the plate spring 40, 40A is pushed in from one side Z1 to the other side Z2 in the third direction Z, the bent end part 46 can be guided and locked smoothly to the locking projection 25d.

Moreover, in the plate spring 40, the bent end part 46 is provided on each of both ends in the second direction Y, and the biasing member locking part 25 is provided at each of the sidewall parts 22 provided on one side Y1 and the other side Y2 in the second direction Y. Thus, for example, the bent end part 46 of the plate spring 40 on one side Y1 in the second direction Y is inserted to the insertion port 25t of the biasing member locking part 25, so that the bent end part 46 can be locked to the locking projection 25d from the other side Z2 in the third direction Z in the locking projection 25d and the bent end part 46 on the other side Y2 can be locked to the locking projection 25d by pushing in the bent end part 46.

Moreover, the plate spring 40A includes the biasing contact part 41 in contact with the second core 12, the inclined contact part 42 that is inclined from one side Z1 to the other side Z2 in the third direction Z from each end part 42a on one side Y1 and the other side Y2 in the second direction Y toward the biasing contact part 41 along the second direction Y, the bent end part 46 provided in the inclined contact part 42 on one side Y1 in the second direction Y, and the biasing member side inclined contact surface 43 that is formed on the surface, on one side Z1 in the third direction Z, of the inclined contact part 42 on the other side Y2 in the second direction Y, the biasing member locking part 25 is provided in the sidewall part 22 on one side Y1 in the second direction Y, and in the sidewall part 22 on the other side Y2 in the second direction Y, the biasing member holding part 23 including the sidewall part side inclined contact surface 23d formed with inclination so as to be in surface contact with the biasing member side inclined contact surface 43 while the plate spring 40A is in the biased state is provided.

Thus, one side of the plate spring 40A can hold the end part by locking between the bent end part 46 and the locking projection 25d, and the other side of the plate spring 40A can hold the end part by the surface contact between the biasing member side inclined contact surface 43 and the sidewall part side inclined contact surface 23d, which are the inclined surfaces. Therefore, for example, the bent end part 46 can be locked to the locking projection 25d in such a way that the other end part 42a of the plate spring 40A simply in the surface contact is inserted by sliding and one end part 42a is pushed in.

The magnetic unit according to any of the embodiments of the present invention described above is not limited to the embodiment described above, and various changes can be made within the scope of the claims.

In the above description, the sidewall parts 22 of the base member 20, 20A are provided on one side Y1 and the other side Y2 in the second direction Y; however, the sidewall part 22 (and the biasing member locking part 25 provided in the sidewall part 22) may be provided on only one of those sides and on the other, another configuration of locking the end part 42a of the plate spring 40, 40A may be formed. Although the plate spring 40, 40A is used as the biasing member, the biasing member in other forms can also be used.

The magnetic unit according to this embodiment may be configured by combining the components in the embodiments and modifications described above as appropriate.

The magnetic unit according to the present embodiment has the effect that the configuration for assembling the biasing member to the case can be properly achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A magnetic unit comprising:
a magnetic core formed in an annular shape about a first direction and including a first core and a second core split along a second direction that intersects with the first direction, in which the second core provided on one side in a third direction that intersects with the first direction and the second direction and the first core provided on the other side in the third direction are in contact with each other along the third direction;
a base member that accommodates the magnetic core and includes a bottom part that supports the first core and a sidewall part that is provided on a side of the magnetic core in the second direction; and
a biasing member with an end part in the second direction held by the sidewall part, the biasing member being configured to bias the second core to the other side in the third direction, wherein
the sidewall part includes a biasing member locking part that is locked to the end part of the biasing member,
the biasing member includes a bent end part corresponding to an end part that is bent toward one side in the third direction, and
the biasing member locking part includes a locking projection that projects to the other side in the third direction so as to be locked to the bent end part.

2. The magnetic unit according to claim 1, wherein
the locking projection includes a guide inclined surface that is inclined on a side of the magnetic core in the second direction.

3. The magnetic unit according to claim 1, wherein
in the biasing member, the bent end part is provided on each of both ends in the second direction, and
the biasing member locking part is provided at each of the sidewall parts provided on one side and the other side in the second direction.

4. The magnetic unit according to claim 2, wherein
in the biasing member, the bent end part is provided on each of both ends in the second direction, and
the biasing member locking part is provided at each of the sidewall parts provided on one side and the other side in the second direction.

5. The magnetic unit according to claim 1, wherein
the biasing member includes a biasing contact part to be in contact with the second core, an inclined contact part that is inclined from one side to the other side in the third direction from each end part thereof on one side and the other side in the second direction toward the biasing contact part along the second direction, the bent end part provided in the inclined contact part on one side in the second direction, and a biasing member side inclined contact surface that is formed on a surface, on one side in the third direction, of the inclined contact part on the other side in the second direction,
the biasing member locking part is provided in the sidewall part on one side in the second direction, and
in the sidewall part on the other side in the second direction, a biasing member holding part including a sidewall part side inclined contact surface formed with inclination so as to be in surface contact with the biasing member side inclined contact surface while the biasing member is in a bias state is provided.

6. The magnetic unit according to claim 2, wherein
the biasing member includes a biasing contact part to be in contact with the second core, an inclined contact part that is inclined from one side to the other side in the third direction from each end part thereof on one side and the other side in the second direction toward the biasing contact part along the second direction, the bent end part provided in the inclined contact part on one side in the second direction, and a biasing member side inclined contact surface that is formed on a surface, on one side in the third direction, of the inclined contact part on the other side in the second direction,
the biasing member locking part is provided in the sidewall part on one side in the second direction, and
in the sidewall part on the other side in the second direction, a biasing member holding part including a sidewall part side inclined contact surface formed with inclination so as to be in surface contact with the biasing member side inclined contact surface while the biasing member is in a bias state is provided.
